(19) United States
(12) Patent Application Publication
(10) Pub. No.: US 2025/0368771 A1
(43) Pub. Date: Dec. 4, 2025

(54) LOW RESILIENCE POLYURETHANE FOAM BASED ON TOLUENE DIISOCYANATE

(71) Applicant: Dow Global Technologies LLC, Midland, MI (US)

(72) Inventors: Qinghao Meng, Angleton, TX (US); Fang Zhang, Midland, MI (US); Erik Riggs, Lake Jackson, TX (US); Morgan Alisa Smith, Angelton, TX (US)

(21) Appl. No.: 18/677,262

(22) Filed: May 29, 2024

(51) Int. Cl. C08G 18/48; C08G 18/16; C08G 18/76; C08G 101/00

(52) U.S. Cl. CPC C08G 18/485; C08G 18/163; C08G 18/4812; C08G 18/7621; C08G 2101/00; C08G 2110/005

(57) ABSTRACT

Polyurethane foam is made from a foam formulation that includes a random copolymer of propylene oxide and ethylene oxide having an oxyethylene content of 40 to 75% by weight, a random and/or block copolymer of propylene oxide and ethylene oxide having an oxyethylene content of 5 to 15% by weight, a silicone surfactant having poly(alkylene oxide) side-chains terminated in a hydrocarbyl or —C(O)R⁴ group where R⁴ is hydrocarbyl, and an organic polyisocyanate comprising at least 70% by weight of toluene diisocyanate and/or an isocyanate-terminated toluene diisocyanate prepolymer. The foam is characterized by low resilience, low compression sets and good airflows.

This invention relates to low resilience polyurethane foams and methods for making them.

Low resilience polyurethane foam is being used increasingly in cushioning applications such as pillows and mattresses, where the low resilience of the foam imparts a feel that consumers perceive as highly comfortable. Low resilience foams are also used in acoustic applications to reduce NVH (noise, vibration and harshness) and in various applications such as earplugs where slow recovery from compression is advantageous. The ball rebound test of ASTM D-3574 is commonly used to evaluate resilience in polyurethane foams; low resilience foams commonly exhibit a resilience of 30% or less on this test and more often less than 10% or even less than 5%, whereas conventional and high resilience foams may exhibit resilience values of 30% and more. Viscoelastic (VE) polyurethane foam is a class of low resilience foam, characterized in part by being flexible but exhibiting slow recovery from compression. Viscoelastic foam returns energy slowly and slowly recovers its original dimensions after being compressed, whereas conventional and high resilience flexible foams do so immediately after a compressive force is released. Recovery time, i.e., the time needed for the foam to recover its initial dimensions after being compressed, may be, for example, at least 0.25 second or up to several seconds for a viscoelastic foam, but is almost instantaneous for conventional and high resilience foams.

Low resilience polyurethane foams are made by reacting a foam formulation that includes one or more polyols, one or more polyisocyanates and one or more blowing agents (typically water). The various starting materials are chosen to produce a foam which is both flexible and low in resilience. Low resilience foam formulations based on each of the two predominant classes of aromatic isocyanates (toluene diisocyanate (TDI) and methylene diphenyl diisocyanate (MDI and polymeric MDI)) have been developed. Formulations based on TDI offer the possibility of reducing the cost of the isocyanate component (compared to MDI and polymeric MDI) due to the lower isocyanate equivalent weight of TDI, and for that reason some foam producers would prefer to manufacture viscoelastic foams using TDI instead of MDI or polymeric MDI.

WO 2023/146423 describes TDI-based viscoelastic foams. The foam formulations described there are remarkably complex, consisting of as many as seven different polyols. The foam products made using TDI as the only polyisocyanate are characterized as having very low airflows, in the range of 0.3 to 2.2 L/min (about 0.01 to 0.04 ft³/min). The complexity of the foam formulation introduces unwanted costs and process control difficulties, and the low airflows can cause a human user's body heat to become trapped, which leads to discomfort.

US 2016/075846 also describes viscoelastic foams made with TDI. The polyol mixtures described in US 2016/075846 are less complex than those of WO 2023/146423 and include large proportions of poly(propylene oxide) homopolymers. As described therein, these TDI-based foams exhibit a strong tendency to shrink because of poor cell-opening. US 2016/075846 proposes to overcome the problem of shrinkage by adding a special silicone cell opener to the foam formulation in addition to a more typical foam-stabilizing surfactant.

What is desired is a method of making low resilience foams based on TDI. The foam formulations should process readily without shrinkage or foam collapse. The resulting foams should exhibit low resilience as well as good airflows and low compression sets, preferably using a simplified mixture of polyols.

The invention in one aspect is a method of making a polyurethane foam, comprising I) forming a reaction mixture comprising:
(A) a polyol mixture comprising
(A-1) 35 to 75 weight percent, based on the total weight of the polyol mixture (A), of a random copolymer of propylene oxide and ethylene oxide, the random copolymer having an oxyethylene content of 40 to 75% by weight, a nominal hydroxyl functionality of 2 to 4 and a number average molecular weight of 800 to 2000 g/mol,
(A-2) 25 to 65 weight percent, based on the total weight of the polyol mixture (A), of a random and/or block copolymer of propylene oxide and ethylene oxide having an oxyethylene content of 5 to 15% by weight, a nominal hydroxyl functionality of 2 to 4 and a hydroxyl number of 28 to 120 mg KOH/g; and
(A-3) 0 to 5 weight percent, based on the total weight of the polyol mixture (A), of one or more additional polyols, different from polyether polyols (A-1) and (A-2), having number average molecular weights greater than 250 g/mol;
(B) 1.5 to 6 parts by weight water per 100 parts by weight of the polyol mixture (A);
(C) 0 to 1 part by weight, per 100 parts by weight of the polyol mixture (A), of one or more compounds having 3 to 8 isocyanate-reactive groups per molecule and a formula molecular weight of up to 250 g/mol;
(D) greater than 0.5 and up to 5 parts by weight, per 100 parts by weight of the polyol mixture (A), of a silicone surfactant having the empirical formula R¹(CH₃)₂Si—[OSi(CH₃)₂]ₓ—[OSi(CH₃)(Y)]_{y}—OSi(CH₃)₂R² (formula I) wherein R¹ and R² are independently hydrocarbyl having up to 10 carbon atoms; x is a number from 5 to 200; y is a number from 2 to 50; each Y is independently —(CH₂)ₙO—(CH₂CH₂O)ₑ—(CH₂CH(R³)O)ₚ—Z (formula II) wherein n is 1 to 10; e is 0 to 30; p is 0 to 30 provided e+p is at least 10; each R³ is independently hydrocarbyl having up to 10 carbon atoms, and each Z is independently selected from the group consisting of hydrocarbyl having up to 10 carbon atoms and C(O)R⁴ where R⁴ is hydrocarbyl having up to 10 carbon atoms;
E) a catalytically effective amount of at least one urethane catalyst; and
F) an organic polyisocyanate comprising at least 70% by weight of toluene diisocyanate and/or an isocyanate-terminated toluene diisocyanate prepolymer, the organic polyisocyanate being present in an amount sufficient to produce an isocyanate index of 60 to 110, and (II) curing the reaction mixture to produce the polyurethane foam.

The process produces polyurethane foam with low resilience low compression sets and beneficial airflow properties, using a simplified polyol mixture.

The polymer mixture comprises Polyols A-1 and A-2, and optionally one or more additional polyols (A-3).

Polyol A-1 is a random copolymer of propylene oxide and ethylene oxide. Polyol A-1 may be a mixture of such random copolymers, each having an oxyethylene content of 40 to 75% by weight, a nominal hydroxyl functionality of 2 to 4 and a number average molecular weight of 800 to 2000 g/mol as measured by gel permeation chromatography against polyether standards. A Polyol A-1 may be produced by copolymerizing an oxide mixture comprising ethylene oxide and propylene oxide onto a starter or mixture of starters having 2 to 4, preferably 2 to 3 and most preferably 3 hydroxyl groups.

The starter compound will have a hydroxyl equivalent weight less than that of the product (Polyol A-1). The starter may have a hydroxyl equivalent weight of, for example 9 to 125 g/equivalent. Examples of starters include ethylene glycol, diethylene glycol, triethylene glycol, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, and alkoxylates (such as ethoxylates and/or propoxylates) of any of these that have a hydroxyl equivalent weight less than that of the product of the polymerization. The starter compound can also be water.

The copolymerization of the oxide mixture is generally performed in the presence of an alkoxylation catalyst. Examples of suitable alkoxylation catalysts include alkali metal hydroxides such as potassium hydroxide, alkali metal alkoxides, so-called double metal cyanide catalyst complexes such as zinc hexacyanocobaltate complexes, modified double metal cyanide catalyst complexes such as described in WO 2012/091968, WO 2018/209069 and WO 2018/209075, and catalyst systems that contain various aluminum compounds such as are described in WO2021/154780 and WO 2021/154783.

The polyol mixture (A) includes all polyols that have number average molecular weights greater than 250 g/mol, as measured by gel permeation chromatography against polyether standards, but excludes silicone compounds such as surfactants. The polyol mixture includes Polyol A-1, Polyol A-2, and optionally up to 5 weight percent of one or more other polyols having a number average molecular weight of greater than 250 g/mol (collectively, Polyol A-3), based on the total weight of the polyol mixture.

Polyol A-1 has a nominal hydroxyl functionality of 2 to 4, preferably 2 to 3 and most preferably 3. Its number average molecular weight by gel permeation chromatography against polyether standards is 800 to 2000 g/mol, especially 800 to 1500 g/mol or 1250 g/mol. Polyol A-1 has an oxyethylene content of 40 to 75 weight-%, preferably 50 to 70 weight-% or 55 to 65 weight-%, based on the total weight of Polyol A-1. Polyol A-1 may have a hydroxyl number of 56 to 280 mg KOH/g, preferably 575 to 280 km KOH/g or 90 to 210 mg KOH/g, as measured according to ASTM 4274-16. In particular embodiments, Polyol A-1 is a nominal triol having a number average molecular weight of 800 to 1250 g/mol and having an oxyethylene content of 55 to 65% by weight.

Polyol A-2 is a random and/or block copolymer of propylene oxide and ethylene oxide. Polyol A-2 may be produced by polymerizing propylene oxide and ethylene oxide onto a starter or mixture of starters having 2 to 4, preferably 2 to 3 and most preferably 3 hydroxyl groups. The propylene oxide and ethylene oxide may be polymerized simultaneously (to produce a random copolymer) or sequentially (to produce a block copolymer). In a particular embodiment, a mixture of propylene oxide and ethylene oxide is polymerized to produce Polyol A-2, Polyol A-2 in this case being a random copolymer. In another particular embodiment, propylene oxide and then ethylene oxide are polymerized sequentially to produce a block copolymer. In a third particular embodiment, a mixture of propylene oxide and ethylene oxide is polymerized, followed by polymerizing more ethylene oxide by itself, to produce a random copolymer capped with oxyethylene units. The starter compound will have a hydroxyl equivalent weight less than that of the product (Polyol A-2). The starter may have a hydroxyl equivalent weight of, for example 9 to 250 g/equivalent. Examples of starters include ethylene glycol, diethylene glycol, triethylene glycol, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, and alkoxylates (such as ethoxylates and/or propoxylates) of any of these that have a hydroxyl equivalent weight less than that of the product of the polymerization. The starter compound can also be water. Useful polymerization catalysts are as described with regard to Polyol A-1.

Polyol A-2 has an oxyethylene content of 5 to 15% by weight, preferably 6 to 14% or 8 to 14%, a nominal hydroxyl functionality of 2 to 4, preferably 2 to 3 or 3, and a hydroxyl number of 28 to 120 mg KOH/g, preferably 40 to 75 or 40 to 60. Polyol A-2 may be a mixture of such random and/or block copolymers, each having an oxyethylene content of 5 to 15% by weight, a nominal hydroxyl functionality of 2 to 4 and a hydroxyl number of 28 to 120 mg KOH/g.

Polyol A-2 may contain dispersed polymer particles. The dispersed polymer particles may be, for example, a isocyanate-based polymer such as polyurea, polyurethane and/or polyhydrazide, or a polymer of one or more vinyl monomers. A polymer of vinyl monomers may be, for example, a polymer or copolymer of an acrylic and/or methacrylic ester, a homopolymer or copolymer of styrene, a homopolymer or copolymer of acrylonitrile, and the like. The dispersed polymer particles may be styrene-acrylonitrile copolymer particles. The dispersed polymer particles are not counted toward the weight of Polyol A-2 are not taken into consideration in determining the hydroxyl number of Polyol A-2. The hydroxyl number of the polyol component of such a dispersion can be determined by measuring the hydroxyl number of the dispersion and multiplying that value by (1-X), where X is the weight fraction of polymer particles in the dispersion as reported by the manufacturer.

Polyol A-1 may constitute 35 to 75% of the total weight of the polyol mixture. A preferred amount is at least 40% or at least 50%, and up to 70% or up to 66%. Polyol A-2 may constitute 25 to 65% of the total weight of the polyol mixture (ignoring the weight of dispersed particles, if any). A preferred amount of Polyol A-2 is at least 30% or at least 34% and up to 60% or up to 50%.

Optional Polyol A-3 is one or more additional polyols having number average molecular weights greater than 250, different from polyether polyols A-1 and A-2. Examples of Polyols A-3 include, for example, polyester polyols; and polyether polyols different from Polyols A-1 and A-2. Polyol A-3 may comprise, for example, a polyether polyol having a nominal functionality of 4 to 8. Polyol A-3 may be, for example, a homopolymer of propylene oxide and/or a homopolymer of ethylene oxide. Polyol A-3 may comprise a random and/or block copolymer of propylene oxide and ethylene oxide having an oxyethylene content of at least 50% by weight, a nominal functionality of 2 to 6 and a hydroxyl number of at most 70 mg KOH/g. Polyol A-3 may be a homopolymer of propylene oxide. Polyol A-3 may be absent. It is particularly preferred that the polyol mixture contains no more than 2 weight percent, especially no more than one weight percent, of a homopolymer of propylene oxide. Most preferably, a homopolymer of propylene oxide is absent.

A preferred amount of water is at least 2 parts per 100 parts by weight of polyol mixture (A), and up to 5.5 parts, up to 5 parts or up to 4 parts.

Component C) of the reaction mixture, when present at all, is present in an amount of up to 1 part by weight, preferably up to 0.5 or 0.25 part by weight, per 100 parts by weight of the polyol mixture (A). The isocyanate-reactive groups of component C) may be hydroxyl, primary amino or secondary amino groups, for example. Such compounds have formula molecular weights of up to 250 g/mol, preferably up to 150 g/mol or up to 125 g/mol. Examples include but are not limited to ethylene glycol, diethylene glycol, triethylene glycol, propylene glycol, dipropylene glycol, tripropylene glycol, cyclohexanedimethanol, glycerin, trimethylolpropane, triethanolamine, diethanolamine, monoethanolamine, monoisopropanolamine, diisopropanolamine and triisopropanolamine.

The silicone surfactant has the empirical formula R¹(CH₃)₂Si—[OSi(CH₃)₂]ₓ—[OSi(CH₃)(Y)]_{y}—OSi(CH₃)₂R² (formula I) wherein R¹ and R² are independently hydrocarbyl having up to 10 carbon atoms; x is a number from 5 to 200; y is a number from 2 to 50; each Y is independently —(CH₂)ₙO—(CH₂CH₂O)ₑ—(CH₂CH(R³)O)ₚ—Z (formula II) wherein n is 1 to 10; e is 0 to 30 and p is 0 to 30 provided e+p is at least 10; each R³ is independently hydrocarbyl having up to 10 carbon atoms, and each Z is independently selected from the group consisting of hydrocarbyl having up to 10 carbon atoms and —C(O)R⁴ where R⁴ is hydrocarbyl having up to 10 carbon atoms.

The [OSi(CH₃)₂] and[OSi(CH₃)(Y)] units are preferably randomly distributed. The (—CH₂CH₂O—) and (—CH₂CH(R³)O—) units of the Y groups are preferably randomly or pseudo-randomly distributed. The Y group is preferably prepared (when p>0) by polymerizing a mixture of ethylene oxide and a higher ethylene oxide (especially 1,2-propylene oxide) onto an ethylenically unsaturated monoalcohol such as vinyl alcohol, allyl alcohol or methylallyl alchohol.

In some embodiments, each R¹ and each R² independently may be methyl, ethyl or phenyl. In some embodiments, each R³ is independently methyl, ethyl or phenyl, preferably methyl. In some embodiments, each Z is independently methyl, ethyl, phenyl or acetyl.

In some embodiments, x is 25 to 200, 50 to 200 or 100 to 200 and y is 5 to 50 or 5 to 40. n in some embodiments is 2 to 5, especially 2 to 3. In some embodiments, e has an average value of 5 to 30, p has an average value 0 to 30, especially 2 to 30, and e+p has an average value of 10 to 60.

In particular embodiments, each R¹ and each R² are independently methyl, ethyl or phenyl, preferably methyl; each R³ is independently methyl, ethyl or phenyl, preferably methyl; each Z is independently methyl, ethyl, phenyl or acetyl; x is 25 to 200, preferably 50 to 200 or 100 to 200, y is 5 to 50 or 5 to 40, n is 2 to 5, especially 2 to 3, e has an average value of 5 to 30, p has an average value of 0 to 30, especially 2 to 30, and e+p has an average value of 10 to 60.

The silicone surfactant may be provided in the form of a solution or dispersion in a diluent. In such a case, it is preferred that the diluent constitute at most 50%, preferably at most 30% of the total weight of the solution or dispersion.

The reaction mixture preferably contains greater than 0.5 parts, preferably at least 0.75 part, of the silicone surfactant (on an active basis, excluding the weight of any diluent that may be present), per 100 parts by weight of the polyol mixture. The reaction mixture may contain up to 5 parts, up to 3 parts or up to 2 parts of the silicone surfactant (on an active basis) per 100 parts by weight of the polyol mixture.

Urethane catalysts (Component E) for purposes of this invention catalyze the reaction between an isocyanate group and an alcohol group and/or water. Among suitable urethane catalysts are tin (II) and tin (IV) catalysts, catalysts that contain other Group III to Group XV metals, tertiary amine compounds, amidines, tertiary phosphines, and the like. Among the useful urethane catalysts are, for example, trimethylamine, triethylamine, N-methylmorpholine, N-ethylmorpholine, N,N-dimethylbenzylamine, N,N-dimethylethanolamine, dialkylimidazole compounds, 2,2′-dimorpholinodiethylether, N,N,″,″-tetramethyl-1,4-butanediamine, N,N-dimethylpiperazine, 1,4-diazobicyclo-2,2,2-octane, tetraalkyl guanidine compounds, 2,2,2-dimethylaminoethoxyethyl methylaminoethanol,N,N-dimethylcyclohexylamine, 1,3,5-tris[3-(dimethylamino)propyl]hexahydro-1,3,5-triazine, triethylenediamine, dimethylalkylamines where the alkyl group contains from 4 to 18 carbon atoms, pentamethyldiethylene triamine, tetramethyl ethylene diamine, dibutyl tin dilaurate, dimethyltin dilaurate, stannous octoate, stannous oleate, stannic chloride, stannous chloride, di-n-butyl tin bis(mercaptoacetic acid isooctyl ester) and other organotin compounds of the formula SnRₙ(OR)₄₋ₙ, wherein R is alkyl or aryl and n is 0-2. A mixture of two or more urethane catalysts may be used.

The urethane catalyst is present in a catalytically effective amount. Tertiary amine and amidine catalysts, for example, may be present when used in an amount of 0.1 to 5 parts or 0.25 to 2 parts by weight per 100 parts by weight of the mixture of polyether polyols. Tin catalysts may be present (when used) in an amount of 0.01 to 1 or 0.1 to 0.25 parts by weight per 100 parts by weight of the mixture of polyether polyols.

The reaction mixture comprises one or more polyisocyanates, wherein the one or more polyisocyanates have an average isocyanate functionality of 2.0 to 2.5, preferably 2.1 to 2.5 or 2.1 to 2.35. The one or more polyisocyanates may have an isocyanate equivalent weight of up to 200 g/equivalent, up to 175 g/equivalent or 80 to 175 g/equivalent, as measured according to ASTM D2572.

The organic polyisocyanate comprises at least 70% by weight of toluene diisocyanate or an isocyanate-terminated toluene diisocyanate prepolymer. Toluene diisocyanate is preferred. Toluene diisocyanate may be the 2,4-isomer, the 2,6-isomer or a mixture of the 2,4- and 2,6-isomers such as a mixture of 75 to 85% of the 2,4-isomer and correspondingly 25 to 15% of the 2,6-isomer or a mixture of 55 to 65% of the 2,4-isomer and correspondingly 45 to 35% of the 2,6 isomer.

Isocyanate-terminated toluene diisocyanate prepolymers are reaction products of a polyol and an excess of toluene diisocyanate. Such a prepolymer may have an isocyanate equivalent weight of, for example, 90 to 500 g/equivalent, especially 90 to 200 g/equivalent.

The one or more isocyanates are provided in an amount sufficient to produce an isocyanate index of 60 to 110.

The polyisocyanate is present (prior to any reaction) in an amount sufficient to produce an isocyanate index of 60 to 110. A preferred isocyanate index is at least 65 and up to 90, up to 85, up to 80 or up to 75. Isocyanate index is 100 times the ratio of the number of isocyanate groups to the number of isocyanate-reactive groups in the reaction mixture, prior to any reaction.

The reaction mixture may further contain optional ingredients such as a flame retardant, one or more fillers and/or reinforcing agents such as fiber glass, carbon fibers, flaked glass, mica, talc, melamine and calcium carbonate; one or more pigments and/or colorants such as titanium dioxide, iron oxide, chromium oxide, azo/diazo dyes, phthalocyanines, dioxazines and carbon black; one or more biocides; one or more preservatives; one or more antioxidants; one or more flame retardants; and the like. Some of these materials may perform multiple functions. Isocyanate-reactive materials other than those specifically mentioned hereinabove may be omitted; if present they preferably are present in an amount of no more than 5 parts by weight per 100 parts by weight of the polyol mixture (A).

Polyurethane foam is made by combining the various ingredients to form a reaction mixture which is then cured. The order of mixing is generally not critical although it is preferred to combine the polyisocyanate after mixing the other ingredients, or at least simultaneously with the mixing of the other ingredients. No special foaming conditions are necessary; therefore, foaming conditions and equipment described in the art for making flexible polyurethane foam are entirely suitable. In general, the isocyanate compounds will react spontaneously with water and the polyols even at room temperature (23° C.) and therefore in some embodiments curing is accomplished without heating to an elevated temperature (apart from a temperature rise associated with a reaction exotherm that takes place during the curing). If necessary, heat can be applied to the reaction mixture to speed the curing reaction. This can be done by heating some or all of the ingredients prior to combining them, by applying heat to the reaction mixture as it cures, or some combination of each. If heat is applied, a suitable elevated temperature is 40 to 80° C. Curing is continued until the reaction mixture has expanded and cured sufficiently to form a stable foam.

In some embodiments, the curing step is performed in a closed mold. In such a process, the reaction mixture is either formed in the mold itself or formed outside the mold and then injected into the mold, where it cures. The expansion of the reaction mixture as it cures is therefore constrained by the internal surfaces of the mold, as are the size and geometry of the molded part. Enough of the reaction mixture is introduced into the mold such that the resulting foam achieves the wanted density as it expands and fills the mold.

In other embodiments, the curing step is performed in a free-rise (or slabstock) process. In the free-rise process, the reaction mixture is poured into an open container such that expansion in at least one direction (usually the vertical direction) occurs against the atmosphere or a lightweight surface (such as a film) that provides negligible resistance to the expansion of the foam. In the free-rise process, the reaction mixture expands in at least one direction essentially unconstrained except by its own weight. The free-rise process may be performed by forming the reaction mixture and dispensing it into a trough or onto a conveyor where it expands and cures.

The low resilience polyurethane foam so produced may have a foam density of, for example, at least 16 g/L, or at least 28 g/L, as measured according to ASTM D3574, Test A. The foam density may be up to 64 g/L, up to 48 g/L, up to 40 g/L or up to 36 g/L.

The low resilience foam may exhibit a resilience of at most 35%, at most 30% or at most 10% as measured by the ball rebound test of ASTM D3574-01.

The low resilience foam may exhibit a recovery time of 0 seconds, at least 0.25 second, at least 0.5 second, at least 1 second, and up to 20 seconds, up to 10 seconds or up to 5 seconds. Recovery time for purposes of this invention is measured by compressing a 2.0-inch (5.08 cm) thick foam piece (4.0×4.0×2.0 inches, 10.16×10.16×5.08 cm) to 24% of its original thickness at room temperature, holding the foam at that compression for one minute and releasing the compressive force. The time required after the compressive force is released for the foam to regain 95% of the original foam thickness is the recovery time. Recovery time is conveniently measured using a viscoelastic foam-testing device such as a RESIMAT 150 device (with factory software) from Format Messtechnik GmbH.

The low resilience foam may exhibit an airflow (after mechanically crushing to open cells) of, for example, 0.02 to 2 L/s, 0.04 to 1 L/s, 0.12 to 0.5 L/s or 0.15 to 0.3 L/s, as measured according to ASTM D3574-01.

The low resilience foam may exhibit a 90% compression set of up to 10%, up to 8%, up to 5% or 1 to 5%, as measured according to ASTM D3574-01.

The low residence foam may exhibit an elongation to break of at least 50%, 50 to 300% or 70 to 200%, as measured according to ASTM D3574-01. The low resilience foam may exhibit a tensile strength of at least 1, or at least 2 MPA, as measured according to ASTM D3574-01. The viscoelastic foam may exhibit a tear strength of at least 40 N/m, at least 50 N/m or at least 60 N/m, as measured according to ASTM D3574-01.

In particular embodiments, the low resilience foam exhibits a density of 28 to 36 kg/m³, a resilience of 2 to 30%, a 90% compression set of no greater than 5% and an airflow of 0.12 to 0.5 L/s.

The low resilience foam of the invention is useful as for other cushioning applications where low resilience and/or long recovery times are required. These applications include, for example, pillows, mattresses and other cushioning applications, acoustic applications to reduce NVH (noise, vibration and harshness), earplugs, deformable sealants, squeezable toys, and the like.

The following examples are provided to illustrate the invention and are not intended to limit the scope thereof. All parts and percentages are by weight unless otherwise indicated.

### EXAMPLES 1-4 AND COMPARATIVE SAMPLE A

Low resilience foams of the invention are made from the foam formulations indicated in Table 1. Comparative foams are made from the formulations set forth in Table 2.

The ingredients are as follows:

Polyol A-1 is a 1000 number average molecular weight random copolymer of ethylene oxide and propylene oxide. It contains 60% by weight oxyethylene units. Its nominal functionality is 3 and its hydroxy number is 168 mg KOH/g.

Polyol A-2A is a 3000 number average molecular weight random copolymer of ethylene oxide and propylene oxide. It contains 13% by weight oxyethylene units. Its nominal functionality is 3 and its hydroxy number is 56.4 mg KOH/g.

Polyol A-2B is a 2000 number average molecular weight block copolymer of 1,2-propylene oxide and ethylene oxide, produced by sequentially polymerizing propylene oxide and then ethylene oxide onto a trifunctional initiator. It contains 12.7% oxyethylene units and has a hydroxyl number of 56.1 mg KOH/g.

Polyol A-3A is a 2000 number average molecular weight homopolymer of propylene oxide. It has a nominal functionality of 2 and a hydroxyl number of 55.5 mg KOH/g.

Polyol A-3B is a 1000 number average molecular weight homopolymer of propylene oxide. It has a nominatal functionality of 3 and a hydroxyl number of 168 mg KOH/g.

Catalyst A is a 70% solution of bis-2-(N,N-dimethylamino)ethyl ether in dipropylene glycol.

Catalyst B is a 33% solution of triethylene diamine in dipropylene glycol.

Catalyst C is stannous octoate.

TDI is an 80/20 mixture of the 2,4- and 2,6-isomers of toluene diisocyanate.

PMDI is a polymeric MDI product having an isocyanate functionality of 2.2 to 2.3 and in isocyanate content of 33% (126 isocyanate equivalent weight).

Surfactant 1 is an undiluted copolymer corresponding to formula I, wherein R¹, R² and each R³ are methyl; x is 100 to 150, y is 5 to 20 and each n is 3. In the Y groups, e has an average value of 10 to 30, p has an average value of 10 to 30, and Z is acetyl (C(O)CH₃).

Surfactant 2 is a mixture of 20% of a diluent and 80% of a copolymer corresponding to formula I, wherein R¹, R² and each R³ are methyl; x is 50 to 200, y is 5 to 40 and each n is 3. In the Y groups, e has an average value of 5 to 30, p has an average value of 0 to 30, e+p has a value of 10 to 50, and Z is acetyl (C(O)CH₃).

Surfactant 3 is an undiluted copolymer corresponding to formula I in all respects except Z is hydrogen. R¹, R² and each R³ are methyl; x is 25 to 100, y is 5 to 30 and each n is 3. In the Y groups, e has an average value of 5 to 20, and p has an average value of 1 to 10.

Surfactant 4 is a mixture of 50% of a diluent and 50% of a copolymer corresponding to formula I, wherein R¹, R² and each R³ are methyl; x is 100 to 200, y is 5 to 40 and each n is 3. In the Y groups, e has an average value of 5 to 30, p has an average value 0 to 30, e+p has a value of 10 to 50, and Z is acetyl (C(O)CH₃).

In all cases, all ingredients except Catalyst C and the isocyanate are mixed for 15 seconds on a laboratory pin mixer at room temperature. Catalyst C is added and mixed in for another 15 seconds. The polyisocyanate is added, followed by another 4 seconds of mixing. The resulting reaction mixture is poured into a 38×38×24 cm box lined with a plastic film and allowed to cure at ambient conditions until a stable polyurethane foam is obtained. The foam is demolded and allowed to cure further overnight at room temperature.

Comparative Foams C1, C2, C3, C5 and C7 either shrank (C1, C5, C7), collapsed (C2) or split (C3). Foam properties are not measured for those foams. Properties of the inventive foams and Comparative Foams C4 and C6 are tested according to the methods of ASTM D3574D. Results are as indicated in Table 3.

TABLE 1
Inventive Foam Formulations

Parts By Weight

| Ingredient | Ex. 1 | Ex. 2 | Ex. 3 | Ex. 4 |
|---|---|---|---|---|
| Polyol A-1 | 59 | 59 | 66 | 59 |
| Polyol A-2A | 41 | 41 | 34 | 0 |
| Polyol A-2B | 0 | 0 | 0 | 41 |
| Water | 2.5 | 2.5 | 2.5 | 2.5 |
| Catalyst A | 0.05 | 0.05 | 0.05 | 0.05 |
| Catalyst B | 0.2 | 0.2 | 0.2 | 0.2 |
| Catalyst C | 0.05 | 0.05 | 0.05 | 0.05 |
| Surfactant 1 | 1 (1) | 0 (0) | 1 (1) | 1 (10 |
| (active) | | | | |
| Surfactant 2 | 0 (0) | 1 (0.8) | 0 (0) | 0 (0) |
| (active) | | | | |
| TDI (index) | 93 | 93 | 93 | 93 |

TABLE 2
Comparative Foam Formulations

| | Parts By Weight | | | | | | |
|---|---|---|---|---|---|---|---|
| Ingredient | C1 | C2 | C3 | C4 | C5 | C6 | C7 |
| Polyol A-1 | 59 | 59 | 17 | 31 | 0 | 59 | 59 |
| Polyol A-2A | 41 | 41 | 83 | 69 | 41 | 0 | 41 |
| Polyol A-3A | 0 | 0 | 0 | 0 | 0 | 41 | 0 |
| Polyol A-3B | 0 | 0 | 0 | 0 | 59 | 0 | 0 |
| Water | 2.5 | 2.5 | 2.5 | 2.5 | 2.5 | 2.5 | 2.5 |
| Catalyst A | 0.05 | 0.05 | 0.05 | 0.05 | 0.05 | 0.05 | 0.05 |
| Catalyst B | 0.2 | 0.2 | 0.2 | 0.2 | 0.2 | 0.2 | 0.2 |
| Catalyst C | 0.05 | 0.05 | 0.05 | 0.05 | 0.05 | 0.05 | 0.05 |
| Surfactant 1 | 0 (0) | 0 (0) | 1 (1) | 1 (1) | 1 (1) | 1 (1) | 1 (1) |
| (active) | | | | | | | |
| Surfactant 3 | 1 (1) | 0 (0) | 0 (0) | 0 (0) | 0 (0) | 0 (0) | 0 (0) |
| (active) | | | | | | | |
| Surfactant 4 | 0 (0) | 1 (0.5) | 0 (0) | 0 (0) | 0 (0) | 0 (0) | 0 (0) |
| (active) | | | | | | | |
| TDI (index) | 93 | 93 | 93 | 93 | 93 | 93 | 0 |
| PMDI (index) | 0 | 0 | 0 | 0 | 0 | 0 | 93 |

TABLE 3
Foam Properties¹

| | Result | | | | | |
|---|---|---|---|---|---|---|
| Property | Ex. 1 | Ex. 2 | Ex. 3 | Ex. 4 | C4 | C6 |
| Recovery Time, s | 2.8 | 3.5 | 1.0 | 1.5 | 11.3 | 20 |
| Air flow, ft³/min (L/s) | 2.0 | 2.8 | 3.0 | 0.6 | 0.3 | 7.9 |
| Density, lb/ft³ (kg/m³) | 2.3 | 2.6 | 2.4 | 2.3 | 2.3 | 2.2 |
| 90% Compression set, % | 3.5 | 2.8 | 1.8 | 2.7 | 64.7 | 86.4 |
| Resilience (%) | 7.4 | 9.2 | 7.5 | 12.8 | 18.2 | 5.6 |

¹C1-C3, C5 and C7 not tested due to failures during foaming.

Examples 1-4, taken together with C1, illustrate the importance of the Z group of the silicone surfactant. When Z is hydrogen as in C1, the cells do not open during foaming and the foam shrinks. When Z is acetyl as in Examples 1-4, excellent quality foam with good properties is obtained.

C2 shows the effect of providing too little of the silicone surfactant. Surfactant 4 corresponds to formula 1 in all respects. However, because of the low amount of active surfactant in the reaction mixture, the foam collapses.

C3, C4 and C6 show the effect of having too much or too little of the A-2 polyol in the reaction mixture. C3 does not produce a usable foam due to splitting. C4 exhibits very low airflow and extremely poor compression set. C6 also exhibits extremely high compression set.

C5 shows the effect of removing the A-1 polyol from the reaction mixture. Cells do not open and the foam shrinks.

C7 shows the effect of substituting polymeric MDI for toluene diisocyanate. Cells do not open and the foam shrinks.

1. A method of making a polyurethane foam, comprising I) forming a reaction mixture comprising:
(A) a polyol mixture comprising
(A-1) 35 to 75 weight percent, based on the total weight of the polyol mixture (A), of a random copolymer of propylene oxide and ethylene oxide, the random copolymer having an oxyethylene content of 40 to 75% by weight, a nominal hydroxyl functionality of 2 to 4 and a number average molecular weight of 800 to 2000 g/mol,
(A-2) 25 to 65 weight percent, based on the total weight of the polyol mixture (A), of a random and/or block copolymer of propylene oxide and ethylene oxide having an oxyethylene content of 5 to 15% by weight, a nominal hydroxyl functionality of 2 to 4, a hydroxyl number of 28 to 120 mg KOH/g; and
(A-3) 0 to 5 weight percent, based on the total weight of the polyol mixture (A), of one or more additional polyols, different from polyether polyols (A-1) and (A-2), having number average molecular weights greater than 250 g/mol;
(B) 1.5 to 6 parts by weight water per 100 parts by weight of the polyol mixture (A);
(C) 0 to 1 part by weight, per 100 parts by weight of the polyol mixture (A), of compounds having 3 to 8 isocyanate-reactive groups per molecule and a formula molecular weight of up to 250 g/mol;
(D) greater than 0.5 and up to 5 parts by weight, per 100 parts by weight of the polyol mixture (A), of a silicone surfactant having the empirical formula R¹(CH₃)₂Si—[OSi(CH₃)₂]ₓ—[OSi(CH₃)(Y)]_{y}—OSi(CH₃)₂R² (formula I) wherein R¹ and R² are independently hydrocarbyl having up to 10 carbon atoms; x is a number from 5 to 200; y is a number from 2 to 50; each Y is independently —(CH₂)ₙO—(CH₂CH₂O)ₑ—(CH₂CH(R³)O)ₚ—Z (formula II) wherein n is 1 to 10; e is 0 to 30; p is 0 to 30 provided e+p is at least 10; each R³ is independently hydrocarbyl having up to 10 carbon atoms, and each Z is independently selected from the group consisting of hydrocarbyl having up to 10 carbon atoms and C(O)R⁴ where R⁴ is hydrocarbyl having up to 10 carbon atoms;
E) a catalytically effective amount of at least one urethane catalyst; and
F) an organic polyisocyanate comprising at least 70% by weight of toluene diisocyanate and/or an isocyanate-terminated toluene diisocyanate prepolymer, the organic polyisocyanate being present in an amount sufficient to produce an isocyanate index of 60 to 110 and, (II) curing the reaction mixture to produce the polyurethane foam.

2. The method of claim 1 wherein the polyether polyol (A-1) constitutes 50 to 66% of the weight of the polyol mixture.

3. The method of claim 1 wherein the polyether polyol (A-2) constitutes 30 to 50% of the weight of the polyol mixture.

4. The method of claim 1 wherein the polyether polyol (A-3) constitutes 0 to 2% of the weight of the polyol mixture.

5. The method of claim 1 wherein the reaction mixture contains 0.75 to 2 parts by weight of the silicone surfactant per 100 parts by weight of the polyol mixture.

6. The method of claim 1 wherein each R¹ and each R² are independently methyl, ethyl or phenyl; each R³ is independently methyl, ethyl or phenyl; each Z is independently methyl, ethyl, phenyl or acetyl; x is 25 to 200, y is 5 to 50, n is 2 to 5, e has an average value of 5 to 30, p has an average value of 0 to 30, especially 2 to 30, and e+p has an average value of 10 to 60.

7. The method of claim 1 wherein the organic isocyanate is a mixture of 60-85 weight % 2,4-toluene diisocyanate and 15 to 40 weight-% 2,6-toluene diisocyanate.

8. A polyurethane foam made according to the method of claim 1.
